(19) United States
(12) Patent Application Publication
(10) Pub. No.: US 2025/0040542 A1
(43) Pub. Date: Feb. 6, 2025

(54) USE OF PHENYLPHENALENONES AS A SELECTIVE HERBICIDE

(71) Applicant: UNIVERSITE DE LIMOGES, Limoges (FR)

(72) Inventors: Mohamad ISSAOUI, Limoges (FR); Catherine RIOU, Isle (FR); Holm AMARA, Limoges (FR); Jérémy GODARD, Limoges (FR); Frédérique BREGIER, Condat sur Vienne (FR); Vincent SOL, Limoges (FR)

(21) Appl. No.: 18/719,070

(22) PCT Filed: Dec. 22, 2022
(86) PCT No.: PCT/FR2022/052474

§ 371 Date: Jun. 12, 2024

(30) Foreign Application Priority Data
Dec. 23, 2021 (FR) FR2114329

(51) Int. Cl. A01N 35/06; A01P 13/02

(52) U.S. Cl. CPC A01N 35/06; A01P 13/02

(57) ABSTRACT

The invention relates to the field of selective herbicides and more specifically to the use of phenylphenalenones of formula (1) as a selective herbicide. The invention also relates to herbicidal compositions and to a method for selective weed control.

### TECHNICAL FIELD

This application relates to the field of selective herbicides.

### PRIOR ART

The combat against weeds is essentially based on the use of non-specific chemical products, posing risks, as is now well known, to users, the environment, and non-target plants.

Furthermore, over the last decade, intensive use of these herbicides has caused multiple health and environmental crises. It is therefore essential to develop new herbicides that are more environmentally friendly and have a reduced impact on human health and on animal and plant biodiversity.

“Natural products” refer to secondary metabolites derived from plants, animals, insects, and microorganisms, and comprise compounds such as alkaloids, terpenes, steroids, polyketides, quinones, lignans, esters, and lactones, to name just a few. Phenalenones are a group of natural products found in both plants and fungi and have significant biological and chemical significance.

Phenylphenalenones and phenalenone derivatives have been found specifically in a large number of plant families such as Haemodoraceae, Pontederiaceae, Strelitziaceae, and Muscaceae.

The majority of phenylphenalenones come from the Haemodoraceae family, including the species Anigozanthos. They are also found in the aquatic plant Eichhornia crassipes (Pontederiaceae), as well as in Musa acuminata and M. paradisiaca (Muscaceae) where they are considered phytoalexins.

Among the phenylphenalenones, anigorufone is considered by some authors to be the simplest phenylphenalenone and was first isolated from a rhizomatous perennial plant belonging to the Haemodoraceae family and called red kangaroo paw (Anigozanthos rufus) (Cooke and Thomas, 1975).

Antiparasitic, antibacterial, and antifungal properties have been described in particular for anigorufone.

Anigorufone, like other phenylphenalenones, is also considered to play a significant role in the plant defense system.

Phytoalexins are metabolites where synthesis is induced in the event of pathogenic attack. These metabolites subsequently give the plant a measure of antimicrobial resistance.

Biological activity seems linked to two phenomena. The first is photosensitizing activity. In light, phenylphenalenones produce reactive oxygen species capable of oxidizing the surrounding molecules, in particular the constituent elements of pathogens (lipids, proteins, nucleic acids). Two mechanisms are conventionally described: Type I, which allows the production of free radicals, and Type II, which allows the production of singlet oxygen (Lazzaro 2004: 10.1039/B401294A, Flors 2006: 10.1021/ar0402863), each of these two mechanisms able to make their contribution, but in principle the Type II mechanism being in the majority.

The second activity would be linked to the planarity of the phenalenone motif. This planarity could induce an action of intercalation with the DNA of pathogens, and would be modulated by the presence of phenyl and hydroxyl groups (Quinones 2000: 10.3390/50700974, Lazzaro 2004).

Unexpectedly, the inventors have demonstrated that phenylphenalenones exhibited selective phytotoxic activity and that therefore they could be used as a herbicide.

### SUMMARY

This invention relates to the use of phenylphenalenones of formula (I):

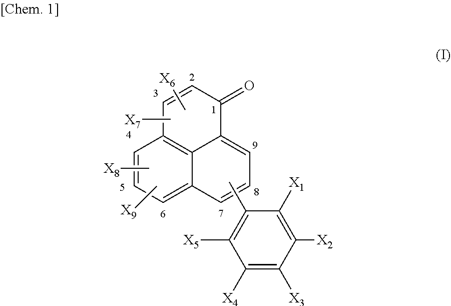

as a selective herbicide,
wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, Cl, —BR, —I, —CONHR;
R may be H, an alkyl, a cellobiose, a glucopyranosyl derivative such as a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, [(6″-O-Allophanyl)-β-D-glucopyranosyl];
the phenyl group and X₆, X₇, X₈, X₉ may be independently positioned at C₂, C₃, C₄, C₅, C₆, C₇, C₈, C₉.

The inventors have indeed advantageously demonstrated that phenylphenalenones may be used as a selective herbicide. While phenylphenalenones significantly inhibit the development of weeds such as poppies, black nightshade, chickweed, ryegrass, lamb's quarters, proso millet, curly dock, and dandelion, they advantageously preserve plants of agronomic interest such as wheat, corn, sunflower, tomato, onion, turnip, and spinach, and do not affect their development.

Thus, phenylphenalenones advantageously preserve non-target plants.

These compounds therefore constitute an alternative to herbicides currently on the market, as they are more environmentally friendly and have a reduced impact on human health and plant and animal biodiversity.

This invention therefore also relates to a selective herbicidal composition comprising
phenylphenalenones of formula (I)
at least one surfactant.

This invention also relates to a method for weed control comprising at least one step of applying phenylphenalenones of formula (I) in a cultivation space, said phenylphenalenones being applied by foliar spraying.

### BRIEF DESCRIPTION OF DRAWINGS

Other features, details, and advantages will become apparent upon reading the detailed description below, and upon analyzing the attached drawings, in which:

FIG. 1 corresponds to the chromatogram and the NMR spectrum of phenyl-9-phenalen-1-one.

FIG. 2 corresponds to the chromatogram and the NMR spectrum of anigorufone.

FIG. 3 A shows the results for two-month-old barley seedlings, not having undergone treatment (control) and having undergone two treatments with 50 μM anigorufone (treated).

FIG. 3 B shows the results for two-month-old tomato seedlings, not having undergone treatment (control) and having undergone two treatments with 50 μM anigorufone (treated).

FIG. 3 C shows the results for two-month-old poppies, not having undergone treatment (control) and having undergone two treatments of 50 μM anigorufone (treated).

FIG. 4 shows the absence of any effect of anigorufone on seven plant species of interest, namely wheat, corn, sunflower, tomato, onion, turnip, and spinach.

FIG. 5 shows the effect of anigorufone on eight weed species, namely poppy, black nightshade, chickweed, ryegrass, lamb's quarters, proso millet, dock, and dandelion.

### DETAILED DESCRIPTION

### Use as Selective Herbicide

This invention thus relates to the use of phenylphenalenones of formula (I)

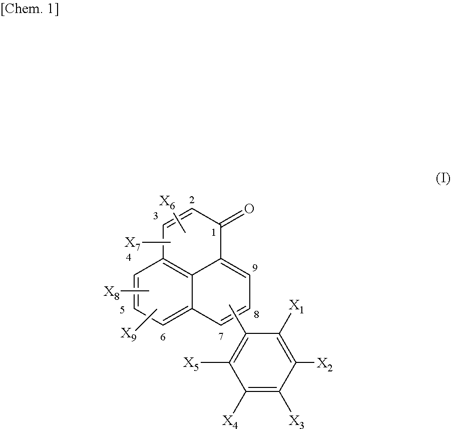

as a selective herbicide,
wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, Cl, —BR, —I, —CONHR; R may be H, an alkyl, a cellobiose, a glucopyranosyl derivative such as a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, [(6″-O-Allophanyl)-β-D-glucopyranosyl];
the phenyl group and X₆, X₇, X₈, X₉ may be independently positioned at C₂, C₃, C₄, C₅, C₆, C₇, C₈, C₉.

Alkyl designates a straight- or branched-chain group containing for example 1, 2, 3, 4, 5, or 6, 7 or 8 carbon atoms. Examples of suitable alkyl radicals are: methyl, ethyl, n-propyl, isopropyl, n-butyl, isobutyl, sec-butyl, tert-butyl, n-pentyl, isopentyl, n-hexyl, etc.

### Phenylphenalenones

Phenylphenalenones may be obtained by any synthesis process, or by isolation from a plant source and in particular from a plant.

Phenalenones found in plants are mostly phenylphenalenones, whose chemical structure consists of a phenalenone ring and a single phenyl substituent.

Phenylphenalenones may be obtained from plants of the Haemodoraceae, Pontederiaceae, Strelitziaceae, Sterculiaceae, and Muscaceae families.

### Phenyl Group at C9: 9-Phenylphenalenones

According to one embodiment, the phenyl group is positioned at C9. Thus, according to one embodiment, the phenylphenalenones are phenylphenalenones of formula (II):

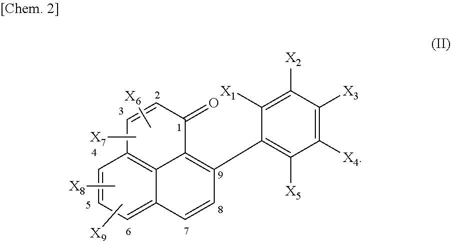

According to one embodiment, the phenylphenalenones are phenylphenalenones of formula (II)

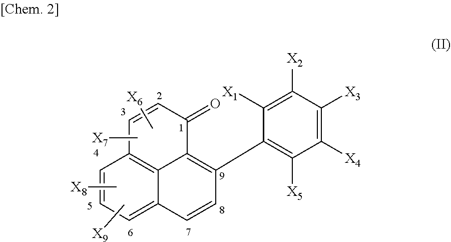

wherein
X₁, X₂, X₃, X₄, X₅, X₆, X₇, X₈, X₉ are independently chosen among —H, —OR;
R may be H, an alkyl, preferably CH₃, a cellobiose, a glucopyranosyl derivative such as a 6-malonyl-β-glucopyranosyl, a 4-O-β-D-glucopyranosyl, a 4-O-[(6″-O-Allophanyl)-β-D-glucopyranosyl];
X₆, X₇, X₈, X₉ may be independently positioned at C₂, C₃, C₄, C₅, C₆, C₇, C₈.

According to one embodiment, the phenylphenalenones will be chosen from the following table:

TABLE 1

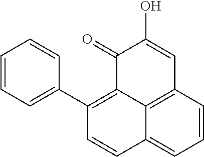 [SMILES: O=C1C(O)=Cc2cccc3ccc(-c4ccccc4)c1c23]

Anigorufone

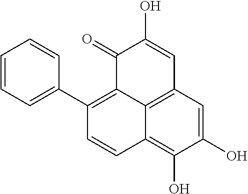 [SMILES: O=C1C(O)=Cc2cc(O)c(O)c3ccc(-c4ccccc4)c1c23]

Lachnanthoside aglycone

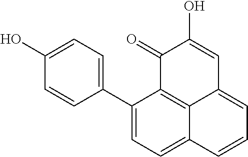 [SMILES: O=C1C(O)=Cc2cccc3ccc(-c4ccc(O)cc4)c1c23]

Hydroxyanigorufone

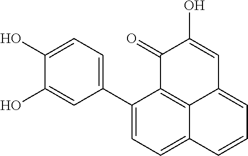 [SMILES: O=C1C(O)=Cc2cccc3ccc(-c4ccc(O)c(O)c4)c1c23]

Dihydroxyanigorufone

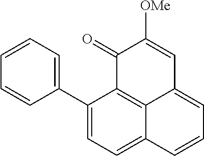 [SMILES: COC1=Cc2cccc3ccc(-c4ccccc4)c(c23)C1=O]

Methoxyanigorufone

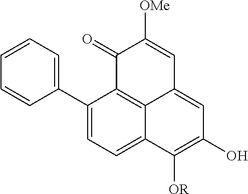

R = cellobiose
Haemocorin

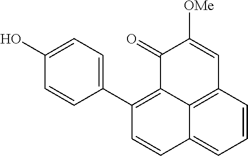 [SMILES: COC1=Cc2cccc3ccc(-c4ccc(O)cc4)c(c23)C1=O]

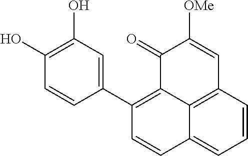 [SMILES: COC1=Cc2cccc3ccc(-c4ccc(O)c(O)c4)c(c23)C1=O]

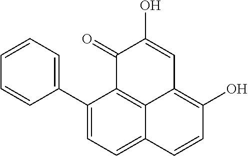 [SMILES: O=C1C(O)=Cc2c(O)ccc3ccc(-c4ccccc4)c1c23]

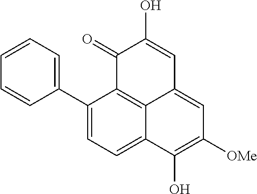 [SMILES: COc1cc2c3c(c(-c4ccccc4)ccc3c1O)C(=O)C(O)=C2]

Haemocorin aglycone

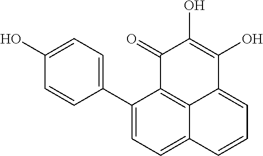 [SMILES: O=C1C(O)=C(O)c2cccc3ccc(-c4ccc(O)cc4)c1c23]

Musanolone E

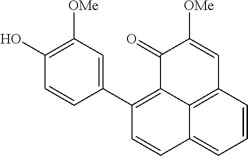 [SMILES: COC1=Cc2cccc3ccc(-c4ccc(O)c(OC)c4)c(c23)C1=O]

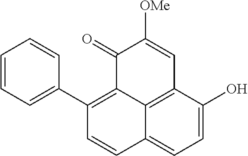 [SMILES: COC1=Cc2c(O)ccc3ccc(-c4ccccc4)c(c23)C1=O]

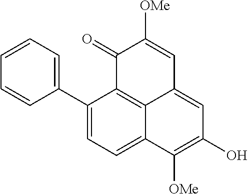 [SMILES: COC1=Cc2cc(O)c(OC)c3ccc(-c4ccccc4)c(c23)C1=O]

Haemoxiphidone

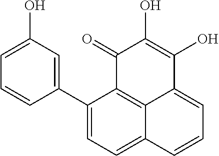 [SMILES: O=C1C(O)=C(O)c2cccc3ccc(-c4cccc(O)c4)c1c23]

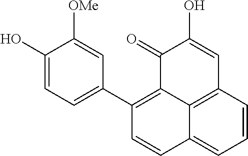 [SMILES: COc1cc(-c2ccc3cccc4c3c2C(=O)C(O)=C4)ccc1O]

Musanolone F

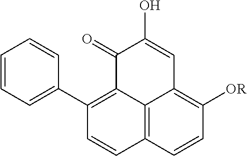

R = 6-malonyl-□-glucopyranosyl

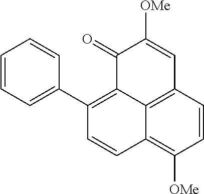 [SMILES: COC1=Cc2ccc(OC)c3ccc(-c4ccccc4)c(c23)C1=O]

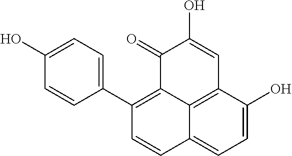 [SMILES: O=C1C(O)=Cc2c(O)ccc3ccc(-c4ccc(O)cc4)c1c23]

Thyrsillorin

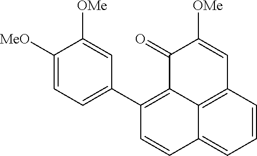 [SMILES: COC1=Cc2cccc3ccc(-c4ccc(OC)c(OC)c4)c(c23)C1=O]

47
R = 4-O—□-_{D}-glucopyranosyl

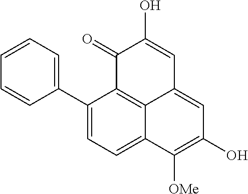 [SMILES: COc1c(O)cc2c3c(c(-c4ccccc4)ccc13)C(=O)C(O)=C2]

Anigozanthin

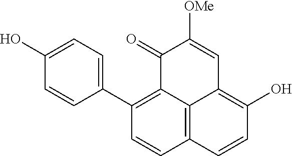 [SMILES: COC1=Cc2c(O)ccc3ccc(-c4ccc(O)cc4)c(c23)C1=O]

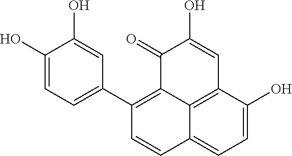 [SMILES: O=C1C(O)=Cc2c(O)ccc3ccc(-c4ccc(O)c(O)c4)c1c23]

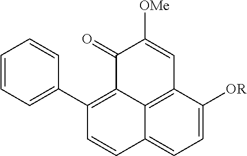

R = 4-O—[(6″—O—Allophanyl)-
□-_{D}-glucopyranosyl]

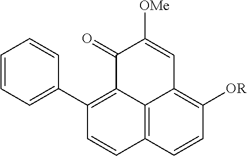

R = 6-malonyl-□-glucopyranosyl

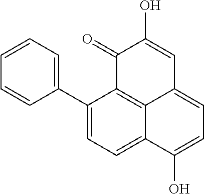 [SMILES: O=C1C(O)=Cc2ccc(O)c3ccc(-c4ccccc4)c1c23]

Lachnanocarpone

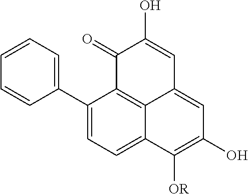

Lachnanthoside
R = unknown diose

### Phenyl Group at C4: 4-Phenylphenalenones

According to one embodiment, the phenyl group is positioned at C4. Thus, according to one embodiment, the phenylphenalenones are phenylphenalenones of formula (III):

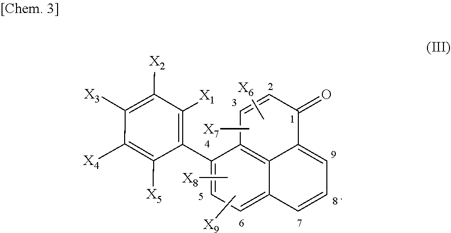

According to one embodiment, the phenylphenalenones are phenylphenalenones of formula (III):

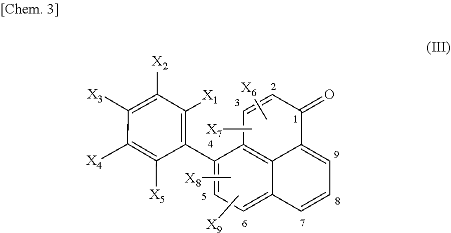

wherein
X₁, X₂, X₃, X₄, X₅, X₆, X₇, X₈, X₉ are independently chosen among —H, —OR; R may be H, an alkyl, preferably CH₃,
X₆, X₇, X₈, X₉ may be independently positioned at C₂, C₃, C₅, C₆, C₇, C₈, C₉.

According to one embodiment, the phenylphenalenones will be chosen from the following table:

TABLE 2

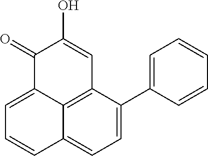 [SMILES: O=C1C(O)=Cc2c(-c3ccccc3)ccc3cccc1c23]

Isoanigorufone
(4′-dehydroxyirenolone)

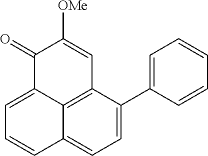 [SMILES: COC1=Cc2c(-c3ccccc3)ccc3cccc(c23)C1=O]

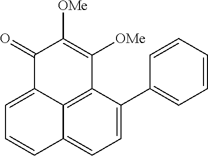 [SMILES: COC1=C(OC)c2c(-c3ccccc3)ccc3cccc(c23)C1=O]

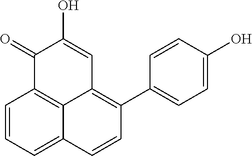 [SMILES: O=C1C(O)=Cc2c(-c3ccc(O)cc3)ccc3cccc1c23]

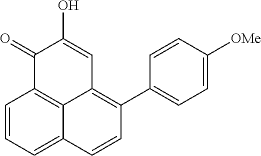 [SMILES: COc1ccc(-c2ccc3cccc4c3c2C=C(O)C4=O)cc1]

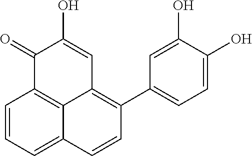 [SMILES: O=C1C(O)=Cc2c(-c3ccc(O)c(O)c3)ccc3cccc1c23]

### Phenyl Group at C7: 7-Phenylphenalenones

According to one embodiment, the phenyl group is positioned at C7. Thus, according to one embodiment, the phenylphenalenone derivatives are phenylphenalenones of formula (IV):

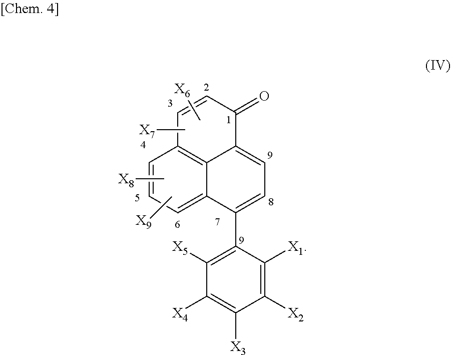

According to one embodiment, the phenylphenalenones are phenylphenalenones of formula (IV)

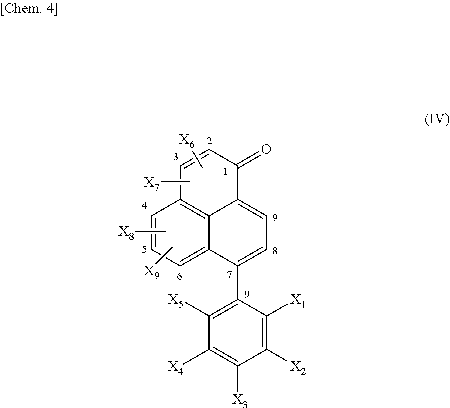

wherein:
X₁, X₂, X₃, X₄, X₅, X₆, X₇, X₈, X₉ are independently chosen among —H, —OR;
R may be H, an alkyl, preferably CH₃, a glucopyranosyl derivative such as a [(6″-O-Allophanyl)-β-D-glucopyranosyl], a 6-O-β-D-glucopyranosyl, a β-D-glucopyranosyl, a 6-malonyl-β-D-glucopyranosyl,
X₆, X₇, X₈, X₉ may be independently positioned at C₂, C₃, C₄, C₅, C₆, C₈, C₉.

According to one embodiment, the phenylphenalenones will be phenylphenalenones chosen from the following table:

TABLE 3

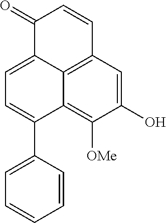 [SMILES: COc1c(O)cc2c3c(ccc(-c4ccccc4)c13)C(=O)C=C2]

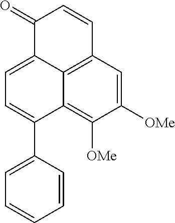 [SMILES: COc1cc2c3c(ccc(-c4ccccc4)c3c1OC)C(=O)C=C2]

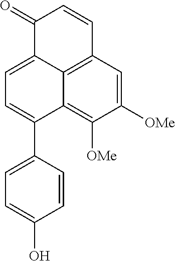 [SMILES: COc1cc2c3c(ccc(-c4ccc(O)cc4)c3c1OC)C(=O)C=C2]

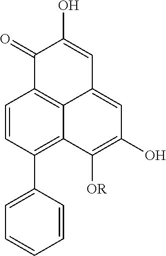

R = [(6″-O—allophanyl)-
β-_{D}-glucopyranosyl]

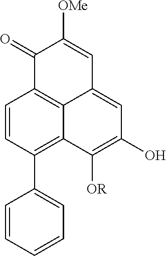

R = [(6″-O—allophanyl)-
β-_{D}-glucopyranosyl]

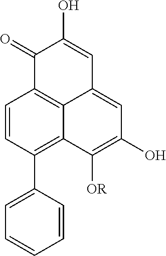

R = 6-O—β-_{D}-
glucopyranosyl

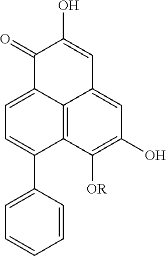

R = β-_{D}-glucopyranosyl

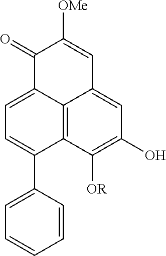

R = 6-malonyl-β-_{D}-
glucopyranosyl

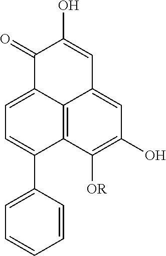

R = 6-malonyl-β-_{D}-
glucopyranosyl

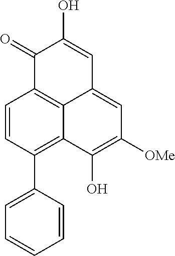 [SMILES: COc1cc2c3c(ccc(-c4ccccc4)c3c1O)C(=O)C(O)=C2]

Haemodorin aglycone

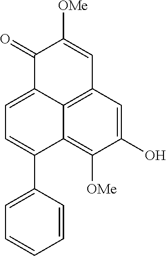 [SMILES: COC1=Cc2cc(O)c(OC)c3c(-c4ccccc4)ccc(c23)C1=O]

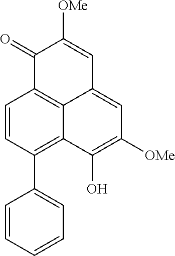 [SMILES: COC1=Cc2cc(OC)c(O)c3c(-c4ccccc4)ccc(c23)C1=O]

Xiphidone

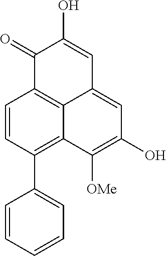 [SMILES: COc1c(O)cc2c3c(ccc(-c4ccccc4)c13)C(=O)C(O)=C2]

Fuliginol

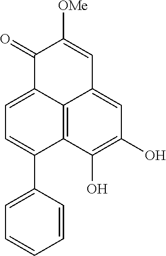 [SMILES: COC1=Cc2cc(O)c(O)c3c(-c4ccccc4)ccc(c23)C1=O]

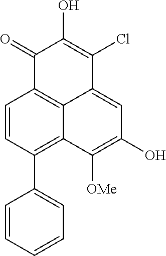 [SMILES: COc1c(O)cc2c3c(ccc(-c4ccccc4)c13)C(=O)C(O)=C2Cl]

3-Chiorofuliginol

### 8-, 6- and 2-Phenylphenalenones

According to one embodiment, the phenylphenalenones will be phenylphenalenones chosen from the following table:

TABLE 4

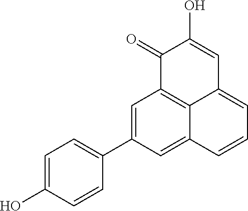 [SMILES: O=C1C(O)=Cc2cccc3cc(-c4ccc(O)cc4)cc1c23]

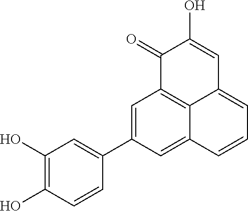 [SMILES: O=C1C(O)=Cc2cccc3cc(-c4ccc(O)c(O)c4)cc1c23]

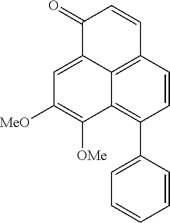 [SMILES: COc1cc2c3c(ccc(-c4ccccc4)c3c1OC)C=CC2=O]

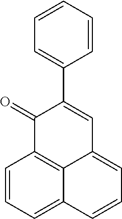 [SMILES: O=C1C(c2ccccc2)=Cc2cccc3cccc1c23]

According to one embodiment, the phenylphenalenones are chosen among anigorufone, p-Hydroxyphenylphenalenone, hydroxyanigorufone, and lachnanthocarpone.

### Anigorufone

According to one embodiment, the phenylphenalenone is anigorufone (CAS number: 56252-32-5) of formula (IV)

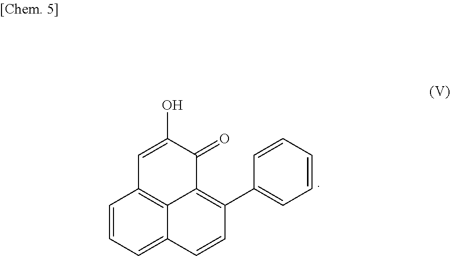 [SMILES: O=C1C(O)=Cc2cccc3ccc(-c4ccccc4)c1c23]

A process for anigorufone synthesis has been described, for example, by Otalvaro et al. in 2004 (Otalvaro 2004: 10.1002/jlcr.808).

Anigorufone may also be obtained from Anigozanthos rufus, Anigozanthos preissii, Wachendorfia thyrsiflora, Macropidia fuliginosa, Musa acuminata, Monochoria elata.

p-Hydroxyphenylphenalenone

According to another embodiment, the phenylphenalenone is p-Hydroxyphenylphenalenone of formula (VI)

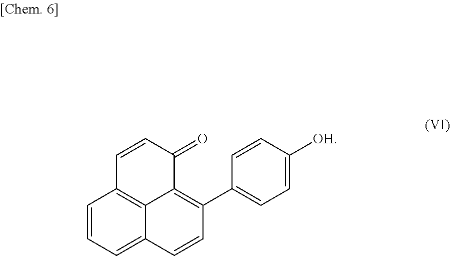 [SMILES: O=C1C=Cc2cccc3ccc(-c4ccc(O)cc4)c1c23]

### Hydroxyanigorufone

According to another embodiment, the phenylphenalenone is hydroxyanigorufone (CAS number: 56252-02-9) of formula (VII)

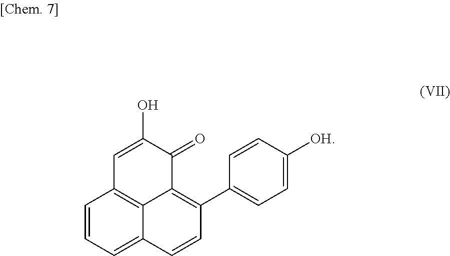 [SMILES: O=C1C(O)=Cc2cccc3ccc(-c4ccc(O)cc4)c1c23]

It may be obtained from Anigozanthos rufus, Anigozanthos preissii, Wachendorfia thyrsiflora, Conostylis setosa, Musa acuminata, Musa itinerans, Musella lasiocarpa, banana cultivars.

p-Hydroxyphenylphenalenone and Hydroxyanigorufone may be obtained by means of the synthesis processes described for example in Quinones 2000 (10.3390/50700974), hydroxyphenylphenalenone being obtained after the demethylation of methoxyphenylphenalenone described in the article.

### Lachnanthocarpone

According to another embodiment, the phenylphenalenone is lachnanthocarpone (CAS number: 28241-21-6) of formula (VIII):

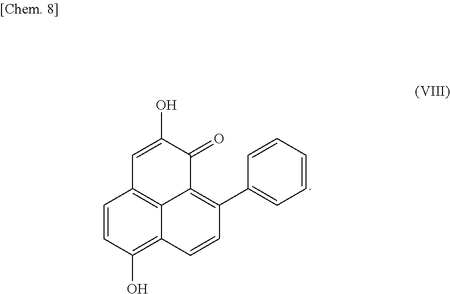 [SMILES: O=C1C(O)=Cc2ccc(O)c3ccc(-c4ccccc4)c1c23]

It may be obtained from Lachnanthes tinctoria, Wachendorfia thyrsiflora, Wachendorfia paniculata, Monochoria elata.

A process for lachnanthocarpine synthesis was also described by Otalvaro et al. in 2004 (Otalvaro 2004: 10.1002/jlcr.808).

### Selective Herbicide

A herbicide is a pesticide for agricultural and domestic use, its activity on plant metabolism causing plant death.

“Selective herbicide” is understood to mean a herbicide which aims to eliminate weeds without harming plants of agronomic interest. It is therefore a question of combating undesirable plants or “weeds” which are unwanted as crops, and preserving the non-target plants (plants of agronomic interest) and the cultivation space.

### Weeds

The term “weed” refers to any herbaceous or woody plant that is found in an agroecosystem without having been intentionally placed there. For example, it will be an undesirable plant species present in a field where another plant species is being grown.

According to one embodiment, the weeds will be chosen among weeds belonging to the Papaveraceae, Amaranthaceae, Poaceae, Polygonaceae, Solanaceae, Asteraceae, Caryophyllaceae, Urticaceae families.

In the Papaveraceae family, we can list weeds of the Papaver genus such as the poppy (Papaver rhoeas).

In the Amaranthaceae family, we can list weeds of the Chenopodium genus such as lamb's quarters (Chenopodium album).

In the Poaceae family, we can list weeds of the Panicum genus such as proso millet (Panicum miliaceum), of the Lolium genus such as ryegrass (Lolium multiflorum), of the Echinochloa genus such as millet (Echinochloa frumentacea).

Among the Polygonaceae family, we can list weeds of the Rumex genus such as curly dock (Rumex crispus).

In the Solanaceae family, we can list weeds of the Solanum genus such as black nightshade (Solanum nigrum), of the Datura genus such as jimsonweed (Datura stramonium).

In the Asteraceae family, we can list weeds of the Taraxacum genus such as the dandelion (Taraxacum officinale).

In the Caryophyllaceae family, we can list weeds of the Stellaria genus such as chickweed (Stellaria media).

In the Urticaceae family, we can list weeds of the Urtica genus such as nettle (Urtica dioica).

Thus, according to one embodiment, the weeds will be chosen among weeds belonging to the genera Papaver, Chenopodium, Panicum, Lolium, Rumex, Solanum, Taraxacum, Stellaria, Urtica, Echinochloa, Datura.

According to a preferred embodiment, the weeds will be chosen among weeds belonging to the genera Papaver, Chenopodium, Panicum, Lolium, Rumex, Solanum, Taraxacum, Stellaria.

According to one embodiment, the weeds will be chosen among poppy (Papaver rhoeas), lamb's quarters (Chenopodium album), proso millet (Panicum miliaceum), ryegrass (Lolium multiflorum), curly dock (Rumex crispus), black nightshade (Solanum nigrum), dandelion (Taraxacum officinale), chickweed (Stellaria media), nettle (Urtica dioica), millet (Echinochloa frumentacea), and jimsonweed (Datura stramonium).

According to a preferred embodiment, the weeds will be chosen among poppy (Papaverrhoeas), lamb's quarters (Chenopodium album), proso millet (Panicum miliaceum), ryegrass (Lolium multiflorum), curly dock (Rumex crispus), black nightshade (Solanum nigrum), dandelion (Taraxacum officinale), and chickweed (Stellaria media).

### Plants of Agronomic Interest

According to one embodiment, the plants of agronomic interest will be chosen among plants belonging to the Solanaceae, Poaceae, Vitaceae, Amaranthaceae, Brassicaceae, Liliaceae, Asteraceae, Rosaceae families.

In the Solanaceae family, we can list plants of agronomic interest of the Lycopersicon genus such as tomato (Lycopersicon esculentum), of the Solanum genus such as potato (Solanum tuberosum), of the Nicotina genus such as tobacco (Nicotiana tabacum).

In the Poaceae family, we can list plants of agronomic interest of the Hordeum genus such as barley (Hordeum vulgare), of the Triticum genus such as wheat (Triticum sativum), of the Zea genus such as corn (Zea mays).

In the Vitaceae family, we can list plants of agronomic interest of the Vitis genus such as the grape vine (Vitis vinifera).

In the Amaranthaceae family, we can list plants of agronomic interest of the Spinacia genus such as spinach (Spinacia oleracea).

In the Brassicaceae family, we can list plants of agronomic interest of the Brassica genus such as turnip (Brassica rapa).

In the Liliaceae family, we can list plants of agronomic interest of the Allium genus such as onion (Allium cepa).

In the Asteraceae family, we can list plants of agronomic interest of the Helianthus genus, such as common sunflower (Helianthus annuus).

In the Rosaceae family, we can list plants of agronomic interest of the Frugaria genus, such as strawberry (Frugaria sp.).

According to one embodiment, the plants of agronomic interest will be chosen among plants of genus Lycopersicon, Solanum, Hordeum, Triticum, Vitis, Spinacia, Brassica, Zea, Allium, Helianthus, Nicotina, Frugaria.

According to a preferred embodiment, the plants of agronomic interest will be chosen among plants of genus Lycopersicon, Solanum, Hordeum, Triticum, Vitis, Spinacia, Brassica, Zea, Allium, Helianthus.

According to one embodiment, the plants of agronomic interest will be chosen among tomato (Lycopersicon esculentum), potato (Solanum tuberosum), tobacco (Nicotiana tabacum), barley (Hordeum vulgare), wheat (Triticum sativum), corn (Zea mays), grape vine (Vitis vinifera), spinach (Spinacia oleracea), turnip (Brassica rapa), onion (Allium cepa), common sunflower (Helianthus annuus), strawberry (Frugaria sp.).

According to one embodiment, the plants of agronomic interest will be chosen among tomato (Lycopersicon esculentum), potato (Solanum tuberosum), barley (Hordeum vulgare), wheat (Triticum sativum), corn (Zea mays), grape vine (Vitis vinifera), spinach (Spinacia oleracea), turnip (Brassica rapa), onion (Allium cepa), common sunflower (Helianthus annuus).

The inventors have therefore advantageously demonstrated that phenylphenalenones, and more particularly anigorufone, significantly inhibit the development of weeds such as poppies, black nightshade, chickweed, ryegrass, lamb's quarters, proso millet, curly dock, and dandelion, and that they preserve plants of agronomic interest such as wheat, corn, sunflower, tomato, onion, turnip and spinach. The selective herbicidal effect is preferentially observed when the phenylphenalenones according to the invention are applied by foliar spraying.

The phenylphenalenones may thus be administered in the environment to be treated by spraying (foliar herbicide).

A foliar herbicide is applied by spraying onto the leaves and requires an adjuvant to help the active ingredient penetrate into the cells (basipetal translocation). Conversely, in the case of a root herbicide, the active ingredient is absorbed by the roots and carried by the sap (acropetal translocation).

### Herbicide Composition

This invention also relates to a selective herbicidal composition comprising
phenylphenalenones of formula (I)

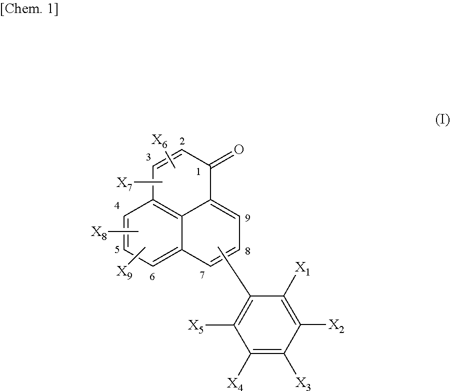

wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, C₁, —BR, —I, —CONHR;
R may be H, an alkyl, a cellobiose, a glucopyranosyl derivative such as a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, [(6″-O-Allophanyl)-β-D-glucopyranosyl];
the phenyl group and X₆, X₇, X₈, X₉ may be independently positioned at C₂, C₃, C₄, C₅, C₆, C₇, C₈, C₉;
at least one surfactant.

The surfactant promotes adhesion and penetration of the phenylphenalenones into the leaves.

According to one embodiment, the surfactant will be chosen among: neutral and non-ionic surfactants such as polyoxyethylene nonylphenyl ether, for example Igepal CO-630 marketed by the company Sigma Aldrich; anionic surfactants such as the products marketed under the name Calsoft®, Texapon®; cationic surfactants such as benzalkonium chloride (BAC) or Benzethonium chloride (BZT); neutral zwitterionic surfactants.

According to one embodiment, the surfactant will be chosen among neutral and non-ionic surfactants, preferably polyoxyethylene nonylphenyl ether.

According to one embodiment, the phenylphenalenones will be present in the composition at a content of between 0.5 and 50 mg/l, preferably between 1 and 40 mg/l, more preferably between 5 and 30 mg/l, even more preferably between 10 and 30 mg/l.

According to one embodiment, the phenylphenalenones will be present in the composition at a content of between 7.5 and 15 mg/l.

According to one embodiment, the phenylphenalenones will be present in the composition at a content of between 15 and 25 mg/l.

According to one embodiment, the phenylphenalenones will be present in the composition at a content of between 25 and 35 mg/l.

### Method for Weed Control

This invention also relates to a method for selective weed control, comprising at least one step of applying phenylphenalenones of formula (I)

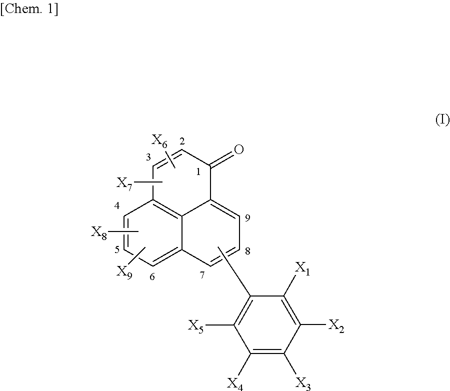

wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, C₁, —BR, —I, —CONHR;
R may be H, an alkyl, a cellobiose, a glucopyranosyl derivative such as a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, [(6″-O-Allophanyl)-β-D-glucopyranosyl];
the phenyl group and X₆, X₇, X₈, X₉ may be independently positioned at C₂, C₃, C₄, C₅, C₆, C₇, C₈, C₉;
in a cultivation space, said phenylphenalenones being applied by foliar spraying or in vitro.

According to one embodiment, the phenylphenalenones are applied by foliar spraying.

### Cultivation Space

Crop or cultivation space is understood to mean any space enabling the cultivation of plants and more particularly plants of agronomic interest. As illustrations, we can list a greenhouse, a field, a meadow, a courtyard, an alley, a flower garden, a vegetable garden.

### Foliar Spraying

“Foliar spraying” is understood to mean the application of phenylphenalenones according to the invention to the parts aboveground, preferably the leaves, of weeds and plants of agronomic interest under cultivation. The phenylphenalenones then produce their selective and systemic herbicidal effect by basipetal translocation.

According to one embodiment of the method for weed control, the phenylphenalenones, when applied by foliar spraying, are sprayed at the cotyledon stage and/or at the first-leaf stage such as the 2-leaf and/or 4-leaf stage.

The term “cotyledon stage” means the stage in which embryonic leaves emerge.

The term “first leaf stage” means the stage in which the first true leaves develop.

### In Vitro Application

In vitro application means introduction of phenylphenalenones into the cultivation medium. The phenylphenalenones will then be absorbed by the roots and carried by the sap (acropetal translocation).

According to one embodiment of the method for weed control, the phenylphenalenones, when applied in vitro, are introduced into the medium before sowing the seeds of the plants of agronomic interest.

According to one embodiment of the method for weed control, the phenylphenalenones, when applied by root application, are introduced into the medium when sowing the seeds of the plants of agronomic interest.

### Selective Herbicide Method

The invention also relates to a selective herbicide method comprising at least one step of applying phenylphenalenones of formula (I)

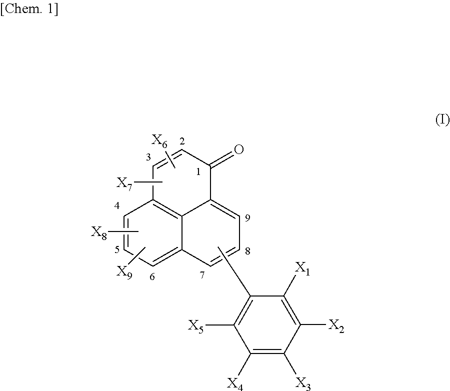

wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, Cl, —BR, —I, —CONHR;
R may be H, an alkyl, a cellobiose, a glucopyranosyl derivative such as a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, [(6″-O-Allophanyl)-β-D-glucopyranosyl];
the phenyl group and X₆, X₇, X₈, X₉ may be independently positioned at C₂, C₃, C₄, C₅, C₆, C₇, C₈, C₉;
in a cultivation space, said phenylphenalenones being applied by foliar spraying or in vitro.

According to a preferred embodiment, the phenylphenalenones are applied by foliar spraying.

The features described above concerning cultivation spaces, foliar application, and in vitro application also apply to this embodiment.

### EXAMPLES

### Materials and Methods

### Formulation of Anigorufone

A 5 mM stock solution was prepared in 50% v/v ethanol (96°). Next, the solution was further diluted in distilled water to obtain 10 μM for in vitro testing and 50 μM, 75 μM and 100 μM for greenhouse testing. 0.1% v/v of the surfactant IGEPAL-Co 630 was added to the solution in order to obtain a product ready for spraying on seedlings in the greenhouse.

It should be noted that ethanol is known as a “green” solvent, and, moreover, its final concentration is equal to 0.5%, 0.75%, and 1% in the formulation (greenhouse application).

### Plant Models

The 18 plant species described below and belonging to several major plant families were tested:

TABLE 2

| Seedling family | Species tested | Classification |
|---|---|---|
| Solanaceae | Tomato | dicot |
| | Lycopersicon esculentum var | |
| | Marmande | |
| Solanaceae | Potato (Solanum tuberosum) | dicot |
| | Cultivars: Duchesse and Coquine | |
| Poaceae | Barley (Hordeum sativum) | monocot |
| Vitaceae | Grape vine (Vitis vinifera) | perennial |
| | Cultivar: Chardonnay | |
| Poaceae | Wheat (Triticum sativum) | monocot |
| Amaranthaceae | Spinach (Spinacia oleracea) | dicot |
| Brassicaceae | Turnip (Brassica napa) | dicot |
| Poaceae | Corn (Zea mays) | monocot |
| Liliaceae | Onion (Allium cepa) | monocot |
| Asteraceae | Sunflower (Helianthus annuus) | dicot |
| Papaveraceae | Poppy (Papaver rhoeas) | dicot |
| Amaranthaceae | Lamb's quarters (Chenopodium album) | dicot |
| Poaceae | Proso millet (Panicum miliaceum) | monocot |
| Poaceae | Ryegrass (Lolium multiflorum) | monocot |
| Polygonaceae | Curly dock (Rumex crispus) | perennial dicot |
| Solanaceae | Black nightshade (Solanum nigrum) | dicot |
| Asteraceae | Dandelion (Taraxacum officinale) | dicot |
| Caryophyllaceae | Chickweed (Stellaria media) | dicot |

### Sterilization of Seeds/Caryopses

Sterilization of the seeds is carried out according to the protocol described below. Surface sterilization is first carried out with 70% (v/v) ethanol for 2 minutes at room temperature. The ethanol is eliminated and the seeds/caryopses are immersed in 20% (v/v) sodium hypochlorite for 15-20 minutes then rinsed thoroughly with sterile water. The seeds/caryopses are left for at least one hour in water before planting.

### In Vitro Multiplication of Clones

The explants are multiplied in a sterile manner, from seedlings that are 1 month old for potatoes and 2 months old for grape vines. The potato explants are multiplied on a synthetic Murashige and Skoog medium supplemented with 2% sucrose and myo-inositol (100 mg/L) pH 5.8. The grape vine explants are grown on ½ Chee and Pool medium supplemented with 2% sucrose, pH 5.9. The media are solidified with 0.8% Sobigel. Both media are supplied by Duchefa Biochemie, Haarlem, Netherlands. The media are autoclaved and after autoclaving (120° C., 20 minutes, 1 bar) and cooling the medium in jars, anigorufone is added at the desired concentration. The grape vine explants are placed in a culture chamber at 25° C. and the potato explants at 23° C., photoperiod 16 h, 22° C., photon flux density ˜100 μmol·m−2·s−1 generated by cool daylight bulbs (OSRAM Lumilux 24W)).

### Greenhouse Cultivation

The different seeds are grown in a greenhouse in commercial potting soil (Terreau Universel, Fertiligene). The seeds were sown in the greenhouse under controlled temperature and humidity conditions (the temperature varies between 15° C. and 30° C. depending on the season, and the relative humidity varies from 50 to 70%). 6 isolated treatments (approximately 10 sprays each) spaced 48 hours apart were carried out one week after germination.

After 7 weeks, the seedlings were harvested. The roots and aboveground parts were separated and the roots were washed with distilled water and dried on absorbent paper. These materials were then stored at −20° C.

### Photodegradation Test

A photodegradation test was conducted on 100 μM anigorufone exposed to sunlight. An anigorufone solution was prepared at the studied dose (100 μM) from a stock solution in 50 ml of distilled water in glass flasks. The flasks were placed outside and exposed to full sunlight. The experiment was carried out three times in June 2022 under light conditions corresponding to sunny/partially clear skies. 1 ml of the solution was run through UV-Vis spectrometry and photodegradation was tracked by the decrease in absorbance at 370 nm.

### Toxicity Test

Fishing worms (maggots) were spray treated with 100 μM (27.2 mg/L) anigorufone. 30 fishing worms were cultured per petri dish and 10 sprays were performed per dish. The fishing worms were cultured under photoperiod conditions (16 h light/8 h dark); 8000 Lux; 22° C.). The experiment was conducted three times.

### Example 1: Synthesis and Characterization of Anigorufone

The synthesis process comprises two reactions:

### Synthesis and Characterization of phenyl-9-phenalen-1-one

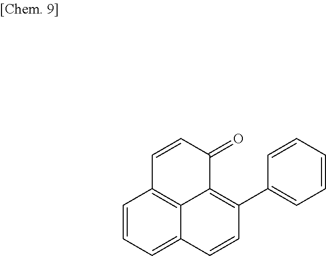 [SMILES: O=C1C=Cc2cccc3ccc(-c4ccccc4)c1c23]

In a 250 mL double-neck flask, 4.68 g (26.7 mmol) of phenalen-1-one (perinaphthenone) are dissolved in 30 mL of anhydrous THF and placed at −40° C. 40 mL of a 1 M solution of phenylmagnesium bromide are added dropwise, and the reaction is maintained for 20 min. Then the flask is transferred to an ice bath, and the reaction is stopped by adding 20 mL of a saturated NH₄Cl solution. The aqueous phase is extracted with CH₂Cl₂, the organic phase is decanted, washed with brine, dried over MgSO₄ and evaporated. The residue is taken up in 30 mL of CH₂Cl₂ and 6.06 g (26.7 mmol) of DDQ are added. The reaction is left to stir for 18 hours at room temperature, then the solvent is evaporated. The reaction crude is purified by column chromatography on silica gel (CH₂Cl₂) to yield 6.2 g (24.3 mmol, 91%) of an orange-yellow oil which crystallizes slowly at room temperature.

¹H NMR (CDCl₃): δ (ppm)=8.17 (d, J=8.2 Hz, 1H), 8.04 (d, J=8.2 Hz, 1H), 7.78 (d, J=7.0 Hz, 1H), 7.69 (d, J=9.7 Hz, 1H), 7.61 (dd, J=7.4, 8.0 Hz, 1H), 7.59 (d, J=8.2 Hz, 1H), 7.45-7.36 (m, 5H), 6.59 (d, J=9.7 Hz, 1H).

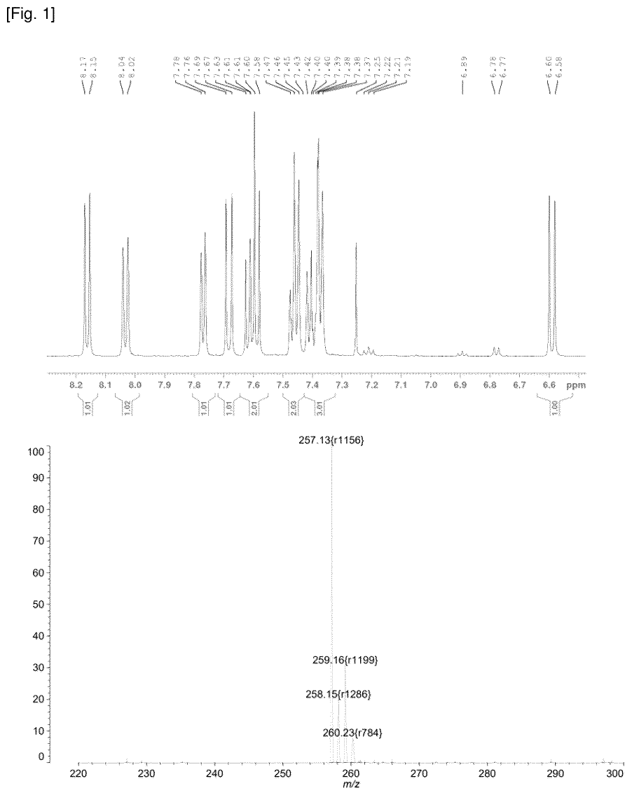

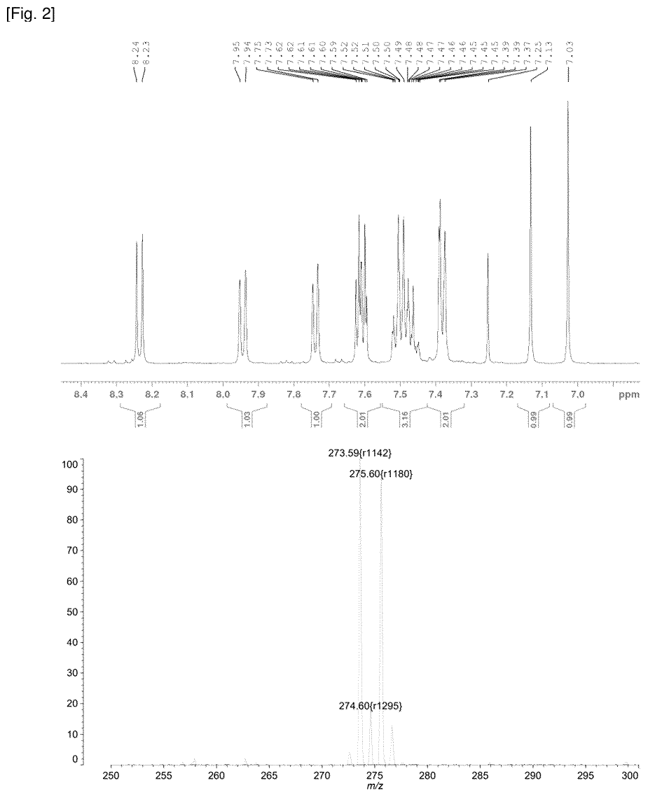

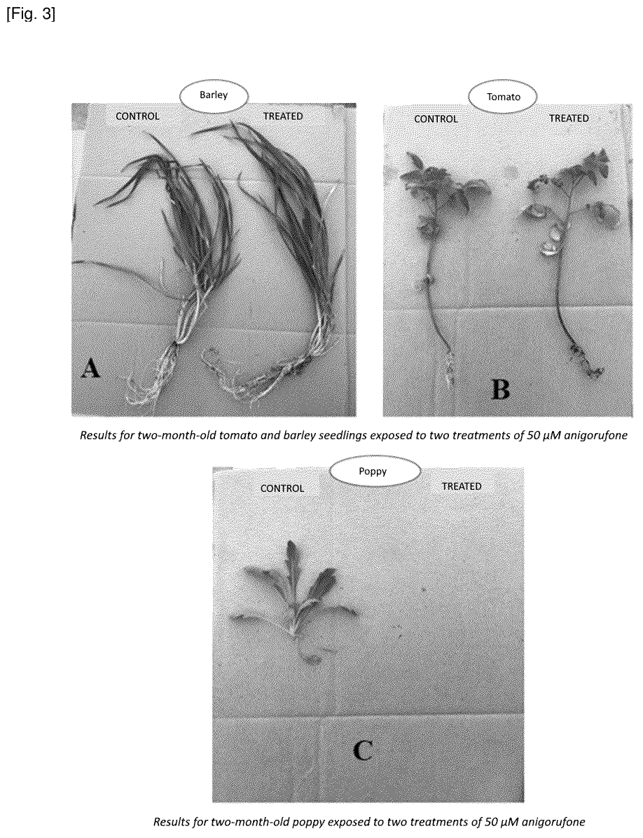

MALDI, m/z calculated for C₁₉H₁₃O [M+H]⁺: 257.1; 257.0 found (FIG. 1).

### Synthesis and Characterization of 2-hydroxy-9-phenylphenalenone (aniqorufone)

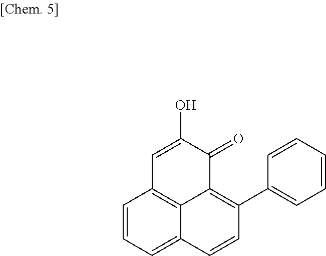 [SMILES: O=C1C(O)=Cc2cccc3ccc(-c4ccccc4)c1c23]

In a 250 mL flask, 5.05 g (19.5 mmol) of 9-phenylphenalenone is dissolved in 20 mL of CH₂Cl₂. 7.48 mL of a 40% aqueous solution of Triton B and 2.01 mL of a 70% aqueous solution of tert-butyl hydroperoxide are added, and the solution is stirred vigorously for two days. The reaction medium is decanted, and the aqueous phase is washed with CH₂Cl₂. The organic phases are combined and the solvent is evaporated. The product is then dissolved in a small volume of CH₂Cl₂ and 3.17 g (19 mmol) of p-toluenesulfonic acid is added. The reaction is left to stir overnight. The reaction mixture is washed with water, the organic phase is recovered, dried and evaporated, and the crude is purified by column chromatography (CH₂Cl₂) to yield 2.95 g (10.8 mmol, 56%) of an orange powder.

¹H NMR (CDCl₃): δ (ppm)=8.24 (d, J=8.2 Hz, 1H), 7.95 (d, J=8.2 Hz, 1H), 7.74 (d, J=7.1 Hz, 1H), 7.60 (d, J=8.2 Hz, 1H), 7.60 (dd, J=7.3, 8.0 Hz, 1H), 7.52-7.37 (m, 5H), 7.13 (s, 1H), 7.03 (s, 1H).

MALDI, m/z calculated for C₁₉H₁₃O₂[M+H]⁺: 273.1; 273.6 found.

### Example 2: Demonstration of the Selective Herbicidal Effect of Aniqorufone

### Results in Greenhouse/Foliar Spraying

The formulation in which the active ingredient is 50 μM Anigorufone was tested on a barley+poppy system and on tomato plants, with two treatments spaced 48 hours apart.

The results for 17-day-old seedlings show efficacy and selectivity on the first system:
The barley is growing normally
The poppy is dead.

On tomatoes, the treatment does not affect their growth compared to the control lot.

This normal growth of the barley and tomato plants persists two months after treatment with 50 μM anigorufone and is similar to the growth of untreated plants (FIG. 3).

Tests in a greenhouse were carried out. All plants were exposed to 6 treatments with 3 increasing doses spaced 48 hours apart: C1 (50 μM or 13.6 mg/l), C2 (75 μM or 20.4 mg/l), C3 (100 μM or 27.2 mg/l). Harvesting was conducted 7 weeks after germination.

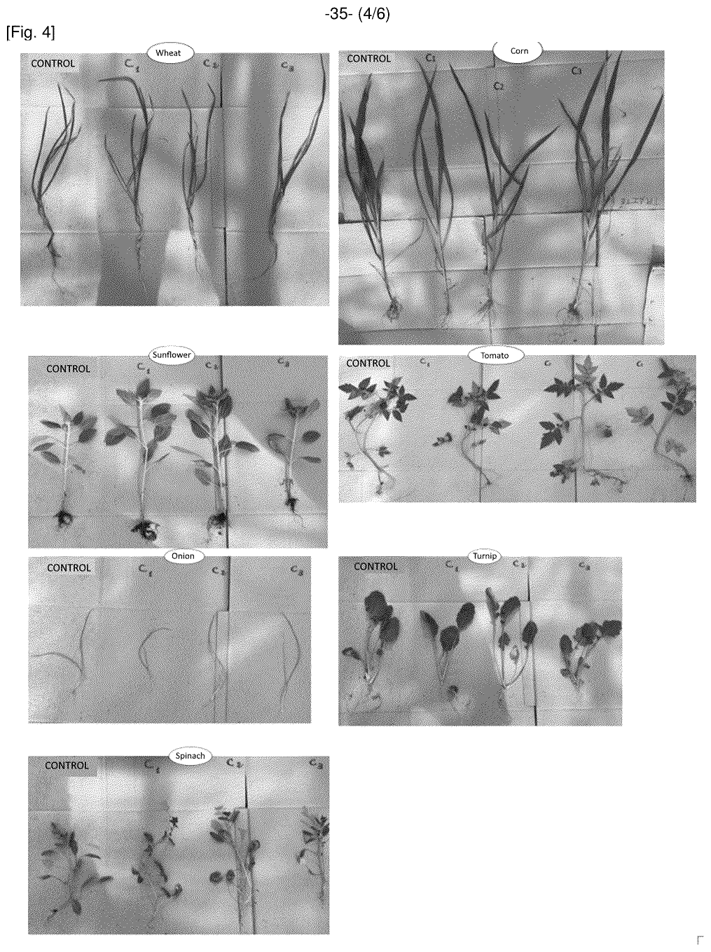

Anigorufone had no effect on 7 species of plants of interest, namely wheat, corn, sunflower, tomato, onion, turnip, and spinach. Surprisingly, we observed flowering induction in sunflowers treated with C1 and C2 (FIG. 4).

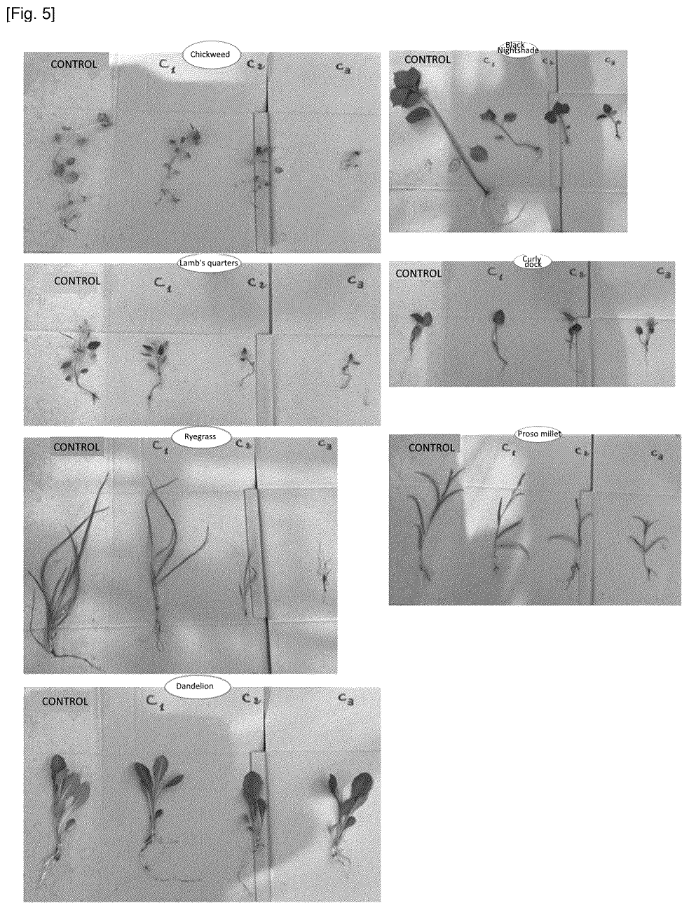

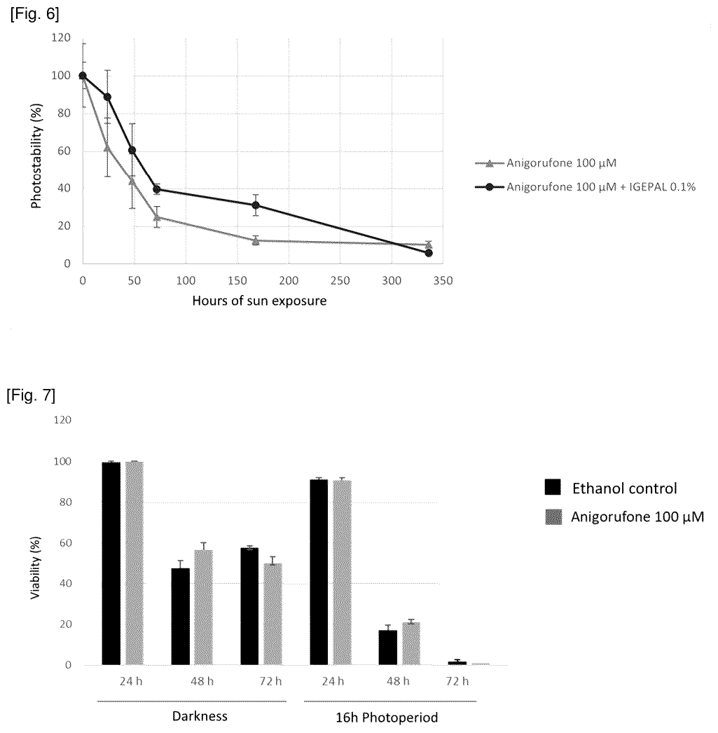

In contrast, the 8 weed species are all affected by the treatments (FIG. 5). Their classification according to the degree of resistance appears below (from least resistant + to most resistant ++++++++):

| Weeds | Resistance |
|---|---|
| Poppy | + |
| Black nightshade | ++ |
| Chickweed | +++ |
| Ryegrass | ++++ |
| Lamb's quarters | +++++ |
| Proso millet | ++++++ |
| Curly dock | +++++++ |
| Dandelion | ++++++++ |

### Example 3: Photodegradation Test of Anigorufone Exposed to Sunlight

A photodegradation test was conducted on 100 μM anigorufone exposed to sunlight.

The results presented in FIG. 6 show that the molecule has degraded rapidly after 72 hours (30-40% persistent molecules), then has degraded almost completely after 2 weeks. The half-life of anigorufone is between 2 and 3 days of sunshine.

This experiment demonstrates that anigorufone is rapidly degraded by the sun and therefore does not persist in the environment after its use as a herbicide, therefore resulting in a reduced impact on plant biodiversity.

### Example 4: Anigorufone Toxicity Test on Fishing Worms (Maggots)

Fishing worms (maggots) were spray treated with 100 μM (27.2 mg/L). The results are presented in FIG. 7.

The viability rate of the maggots under the anigorufone treatment conditions compared to the control conditions remains constant, which indicates that this molecule tested at 100 μM has no effects on fishing worms.

This experiment demonstrates that anigorufone has no toxicity for animal species such as fishing worms and is therefore of great interest as a herbicide having a reduced impact on animal biodiversity.

1. Method for selective weed control, in a cultivation space, comprising at least one step of applying phenylphenalenones of formula (I) 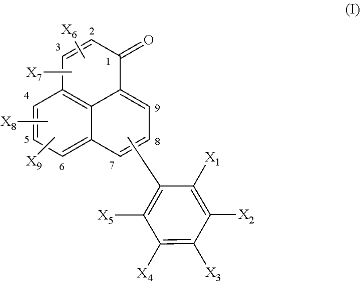
wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, Cl, —BR, —I, and —CONHR;
R is H, an alkyl, a cellobiose, a glucopyranosyl derivative; and wherein
the phenyl group and X₆, X₇, X₈, X₉ are independently positioned at C₂, C₃, C₄, C₅, C₆, C₇, C₈, C₉.

2. Method according to claim 1, wherein the phenylphenalenones are phenylphenalenones of formula (II)

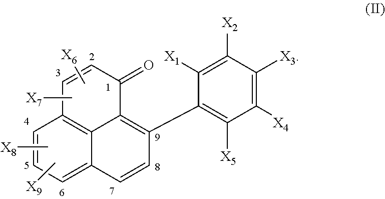

3. Method according to claim 1, wherein the phenylphenalenones are phenylphenalenones of formula (III)

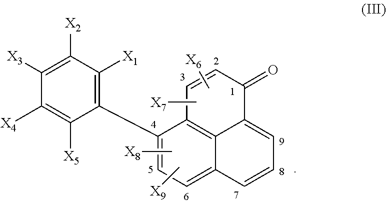

4. Method according to claim 1, wherein the phenylphenalenones are phenylphenalenones of formula (IV)

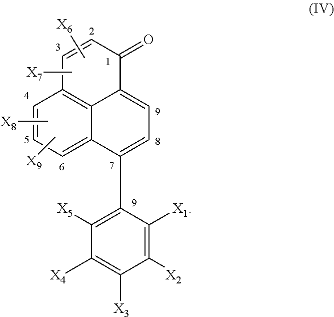

5. Method according to claim 1, wherein the phenylphenalenones are chosen among anigorufone, p-hydroxyphenylphenalenone, hydroxyanigorufone, and lachnanthocarpone.

6. Method according to claim 1, wherein the phenylphenalenones are used for the treatment of plants belonging to the Solanaceae, Poaceae, Vitaceae, Amaranthaceae, Brassicaceae, Liliaceae, Asteraceae, and/or Rosaceae families.

7. Method according to claim 1, wherein the phenylphenalenones are used for the treatment of plants of genus Lycopersicon, Solanum, Hordeum, Triticum, Vitis, Spinacia, Brassica, Zea, Allium, Helianthus, Nicotiana, and/or Frugaria.

8. Method according to claim 1, wherein the phenylphenalenones have an herbicidal effect on weeds belonging to the Papaveraceae, Amaranthaceae, Poaceae, Polygonaceae, Solanaceae, Asteraceae, Caryophyllaceae, and/or Urticaceae families.

9. Method according to claim 1, wherein the phenylphenalenones have an herbicidal effect on weeds belonging to the genera Papaver, Chenopodium, Panicum, Lolium, Rumex, Solanum, Taraxacum, Stellaria, Urtica, Echinochloa, Datura.

10. Selective herbicidal composition comprising
phenylphenalenones of formula (I) 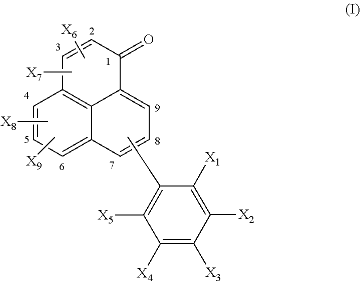
wherein:
X₁, X₂, X₃, X₄, X₅, X₆, X₇, X₈, X₉ are independently chosen among —H, —OR, —NO₂, —NR₂, —CF₃, —COOR, —F, —NHCOR, —SO₃R, Cl, —BR, —I, —CONHR;
R may be H, an alkyl, a cellobiose, a glucopyranosyl derivative;
the phenyl group and X₆, X₇, X₈, X₉ are independently positioned at C₂, C₃, C₄, C₅, C₆, C₇, C₈, C₉; and
at least one surfactant.

11. Method of claim 1,
wherein said phenylphenalenones are applied by foliar spraying.

12. The method of claim 1, wherein the glucopyranosyl derivative is a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, or [(6″-O-Allophanyl)-β-D-glucopyranosyl].

13. The selective herbicidal composition of claim 10, wherein the glucopyranosyl derivative is a 4-O-β-D-glucopyranosyl, a 4-O-[(6″-O-Allophanyl)-β-D-glucopyranosyl], a 6-malonyl-β-glucopyranosyl, a 6-malonyl-β-D-glucopyranosyl, a 6-O-β-D-glucopyranosyl, a β-D-glucopyranosyl, or [(6″-O-Allophanyl)-β-D-glucopyranosyl].
